(19) United States
(12) Patent Application Publication
(10) Pub. No.: US 2026/0235516 A1
(43) Pub. Date: Aug. 13, 2026

(54) SECURITY MARKING AND VERIFICATION SYSTEM

(71) Applicant: Sun Chemical Corporation, Parsippany, NJ (US)

(72) Inventors: Mohammad S. FARAHAT, Carlstadt, NJ (US); Maura MOSTOWY-GALLAGHER, Carlstadt, NJ (US); Carl S. WEISBECKER, Carlstadt, NJ (US)

(73) Assignee: Sun Chemical Corporation, Parsippany, NJ (US)

(21) Appl. No.: 19/145,676

(22) PCT Filed: Jan. 17, 2024
(86) PCT No.: PCT/US2024/011872

§ 371 Date: Jul. 3, 2025

Related U.S. Application Data
(60) Provisional application No. 63/439,671, filed on Jan. 18, 2023.

(51) Int. Cl. G01N 21/64; B41M 3/06; B41M 3/14; B42D 25/382; C09D 11/50; G06V 10/143; G06V 10/145; G06V 10/75; G06V 20/00; G07D 7/1205

(52) U.S. Cl. CPC G01N 21/6456; B41M 3/06; B41M 3/144; B42D 25/382; C09D 11/50; G01N 21/6428; G06V 10/143; G06V 10/145; G06V 10/751; G06V 20/95; G07D 7/1205; G01N 2021/6439; G07D 2207/00

(57) ABSTRACT

The present invention provides a method of producing a security mark by printing with a security ink, and an optical detection method to authenticate the security mark. The security ink contains an organic fluorescent molecule in an aggregated state with a highly red-shifted and broadened fluorescence spectrum compared to the monomeric state of the same material, and capable of tuning of the wavelength and intensity of fluorescence as a function of concentration.

### CROSS REFERENCE TO RELATED APPLICATIONS

The present application claims priority to U.S. Provisional Application No. 63/439,671, filed 18 Jan. 2023, which is hereby incorporated in its entirety.

### FIELD OF THE INVENTION

The present invention is related to the field of determining the authenticity of an article, such as a banknote or other security document. The present invention is relates to a method of producing a security mark by printing with a security ink, and an optical detection method to authenticate the printed security mark.

### BACKGROUND OF THE INVENTION

Security systems using fluorescent taggants and optical systems to detect the fluorescence are known in the art. However, taggants or security markers with single molecular structures, as is currently generally used, exhibit only molecular optical properties, and they can be easily forged due to relatively abundant availability of such materials.

EP3825140 discloses a security mark, a method for detecting a security mark, and a system for detecting a security mark. EP3825140 refers to a safety mark irradiated by light from an optical system for purpose of detecting the security mark. The security mark reflects, absorbs, or emits light in different wavelength ranges in a complex manner so that the authentic security mark is certainly distinguishable from a forged mark. The inventors provide no guidance how to construct the hypothetical security mark that reflects, absorbs, or emits light in the required wavelength ranges to enable their scheme. The proposed behavior described in EP3825140 can be achieved by using readily available fluorescent materials that could be incorporated into a printing ink, however, the two verification methods could not be achieved by readily available fluorescent materials simultaneously. Common fluorescent materials do not produce fluorescence and strong reflectance spectra when incorporated into a printed ink. Such common materials either show strong reflectance when used in high concentration with the absence of fluorescence, or fluorescence when used in low concentrations with negligible reflectance. No explanation is given in EP3825140 about how to achieve this dual spectral verification of reflectance and fluorescence with a single material.

DE102016011766 provides a detection method and device for detecting security features in deposit systems. DE102016011766 refers to a security marking illuminated by light from an optical system using a plurality of different wavelengths. The marking has color reflection behavior which is known at the specific illumination wavelengths, and this known information is used to validate the authenticity of the mark. No claim is made about a fluorescent taggant or optical detection of fluorescence.

US 2021/0264187 (WO 2020/003909) is directed to an inspection method and inspection device for inspecting security markings. The security marking has different reflectivity in different light wavelength ranges, and this information is used to validate the authenticity of the mark. No claim is made about a fluorescent taggant or optical detection of fluorescence.

EP3570256 provides a testing method and reading device for a security mark. EP3570256 claims a security marking test method in which there exists a contrast field with high and low reflection of light in different wavelength ranges. Light intensity difference values are determined and used to validate the authenticity of the security marking. No claim is made about a fluorescent taggant or optical detection of fluorescence.

EP1821096 describes a signet applied to the surface of a package for the purpose of improving the reading of a sign on the package. The signet contains within it a plurality of adjacent fields with different reflective properties. Some adjacent fields have different reflectivity in visible light wavelengths versus infrared light wavelengths. The substrate background of adjacent fields may be a metallic background or a diffuse scattering background. A read-out unit detects intensities of reflected light from adjacent fields in different wavelength ranges. No claim is made about a fluorescent taggant or optical detection of fluorescence.

WO 2018/224107 (EP3635695; DK180215) refers to a method for validating the authenticity of a security mark on a recyclable container. The security mark is illuminated with first, second, and possibly third wavelength ranges. Measured reflectivities in different wavelength ranges are returned to a central validation unit. No claim is made about a fluorescent taggant or optical detection of fluorescence.

US 2020/0130399 (EP3634772) refers to a security mark on a recyclable container with an illustration composed of two parts. One part has reflectance between 0 and 20 percent in the visible spectrum up to 660 nm and reflectance above 80 percent in infrared light having a wavelength above 800 nm. A second part has reflectance between 0 and 20 percent in light having a wavelength up to 800 nm and reflectance above 25 percent in infrared light having a wavelength above 960 nm. One or more images are captured to detect reflected light in different wavelengths to validate the mark. No claim is made about a fluorescent taggant or optical detection of fluorescence.

DE10247252 refers to a security code consisting of an image representation. The entire image representation is visible to the human eye in visible light, but a portion of the image is invisible in infrared light. No claim is made about a fluorescent taggant or optical detection of fluorescence.

EP0628927 (DE4319555) discloses a marking in the form of at least two color symbols which are applied to the surface of an object, in particular packaging. The marking is characterized in that the color symbols consist of different colors, such that each color symbol has at least one different spectral range in the reflecting light compared to the other color symbol.

DE102006011143 provides a security labeling system, e.g. for glass bottles, that has a security code and a spatially separated reference field, such that the reference field is provided inside and/or outside of the area of the security code. The reference mentions a security mark that has a visible absorbance (color), but is transparent in the near infra-red (IR) range. This characteristic by itself is common to almost all colorants using organic dyes or pigments. DE102006011143 discloses a security marking system composed of at least two different color elements that, under normal light, the whole pictorial representation can be recognized by the image processing device as perceptible by the human eye, and that, when illuminating with infrared light, part of the representation remains invisible to the human eye but becomes visible to the image processing device or becomes invisible to the camera with an infrared color of opposite effect. No claim is made about a fluorescent taggant or optical detection of fluorescence.

DE102013103527 discloses an image recording system used for image acquisition of features of an identification document. The imaging system identifies a document in different wavelength ranges of light.

U.S. Pat. No. 8,717,625 describes methods of marking a substrate with an emissive image, articles marked with an emissive image, and authentication methods involving the same. U.S. Pat. No. 8,717,625, and other citations, refers to colored emissive inks and authentication methods used to authenticate a printed image, but these others do not contemplate a security mark that reflects, absorbs, or emits light in different wavelength ranges ranging from visible to infrared in a complex manner as in the taggant security system of the present invention.

U.S. Pat. No. 7,914,703, WO 2008/067445, and U.S. Pat. No. 8,211,333 disclose poly(oxyalkylene) ated colorants, and their use as fluorescent security taggants.

U.S. Pat. No. 7,513,437 discloses a security mark consisting of a plurality of layers which form a card. The cover layers are highly conductive films, and the layers of the card core are films of varying transparency. One layer carries information, which can be read directly, above a security print, while the transparent conductive layer has an additional security marking, such as biometric or product identifiers which can be read conductively only with the aid of a special reader.

U.S. Pat. Nos. 5,569,317, 5,502,304, 5,542,971, and 5,525,798 refer to printing inks with a taggant that is undetected under the light of the visible spectrum (400-700 nm wavelength range), but the taggant luminesces with the irradiation by light in the ultraviolet spectrum (200-380 nm wavelength range).

U.S. Pat. Nos. 5,611,958 and 5,766,324 describe printing inks containing a taggant that is undetected in the visible spectrum (400-700 nm wavelength range), but is detected when irradiated with light in the infrared spectrum (800-600 nm wavelength range).

US 2013/0234043 (CN104272139) discloses an item, such as a postage stamp, to which an adhesive has been applied. A taggant is interspersed in the adhesive, where the taggant emits luminescence when illuminated by an excitation signal. The authenticity of the article is determined based on the sensed emitted luminescence. In one embodiment, the taggant luminesces in the IR range.

U.S. Pat. No. 9,767,337 describes indicia readers configured with multiple illumination light source, where a secondary light source may be a UV light source. The readers are designed to limit exposure of the users to harmful UV light.

U.S. Pat. No. 11,267,979 discloses a fluorescent ink containing molecules with integrated macrocyclic rings, producing aggregated fluorescence under the influence of external additives or stimuli. The inks contain complex fluorescent dyes that are heterorotaxanes, that include large macrocyclic rings around fluorophores and are capable of emitting solid-state fluorescence. When the heterorotaxanes are combined with encapsulating agents and competitive binding agents in aqueous solution, the resulting ink composition exhibits a complex, dynamic equilibrium that provides a tunable fluorescence emission spectrum with a non-linear response to the dye concentration.

The aggregation induced emission process is described in a two volume set edited by A. Qin and B. Z. Tang, and numerous examples are provided. Aggregation-induced emission: Fundamentals and Applications. Qin, A. and Tang, B. Z. Ed., John Wiley & Sons (2013).

Security systems using fluorescent taggants and optical systems to detect the fluorescence are known in the art. However, they generally use taggants or security markers with single molecular structure, and exhibit only molecular optical properties. They can be easily forged due to relatively abundant availability of such materials. Thus, there is still a need for more secure, less easily forged security systems.

Citation or identification of any document in this application is not an admission that such represents prior art to the present invention.

### BRIEF SUMMARY OF THE INVENTION

The present invention provides a method and a system for determining the authenticity of items, such as security documents, retail products, and the like. The method and system of the present invention utilize unique features of certain organic compounds that emit fluorescent light more strongly as the concentration increases (e.g. concentration in an ink).

In a particular aspect, the present invention provides a method of producing a substrate with a printed security mark, comprising:
(a) providing a substrate;
(b) providing a security ink, wherein the security ink comprises a taggant, wherein the taggant is an organic compound that forms a fluorescent aggregate with a Stokes shift of greater than 50 nm as its concentration increases, without the use of any aggregation-inducing additives;
(c) printing the security ink on the substrate; and
(d) drying or curing the security ink on the substrate;
to provide a substrate with a printed security mark.

In another aspect, the present invention provides a method of authenticating a security mark printed on a substrate, comprising:
(a) providing an authentication assembly, wherein the assembly comprises:
   i. one or more light sources;
   ii. one or more cameras;
   iii. one or more lenses;
   iv. one or more light filters; and
   v. image capture utilities;
(b) providing a substrate with a printed security mark prepared by the method of claim 1;
(c) placing the substrate with the printed security mark in front of the camera in the assembly;
(d) illuminating the substrate with the printed security mark with a specific wavelength of light suitable for the security mark;
(e) detecting and measuring absorption, reflection, or fluorescence of all or portions of the security mark on the substrate with a printed security mark when illuminated with light, using the image capture utilities;
(f) acquiring one image of the security mark at a first wavelength, or one or more multispectral images of the security mark at varying wavelengths, using the image capture utilities; and
(g) comparing the spectral images of the security mark to a known standard;
wherein a match to the known standard indicates authenticity of the security mark, and distinguishes it from counterfeit marks.

In yet a further aspect, the present invention provides a method of authenticating a security mark printed on a substrate, comprising:
(a) providing an authentication device, wherein the authentication device comprises:
   i. one or more light sources;
   ii. an electronic sensor with one or more detection channels with optical filters;
   iii. an electronic control circuit; and
   iv. a control program for data capture;
(b) providing a substrate with a printed security mark prepared by the method of claim 1;
(c) placing the substrate with the printed security mark in front of the authentication device;
(d) illuminating the substrate with the printed security mark with a specific wavelength of light suitable for the security mark;
(e) detecting and measuring the fluorescence of all or portions of the security mark on the substrate with the printed security mark when illuminated with light, using the device control program;
(f) comparing the sensor data of the security mark to a known standard;
wherein a match to the known standard indicates the authenticity of the security mark, and distinguishes it from counterfeit marks.

These and other objects, advantages, and features of the invention will become apparent to those persons skilled in the art upon reading the details of the formulations and methods as more fully described below.

### BRIEF DESCRIPTION OF THE DRAWINGS

FIG. 1 illustrates J- and H-aggregate structures and corresponding electronic energy level diagram shifts versus monomer dye for the ideal case of close-interacting dimers.

FIG. 2a depicts the normalized reflectance spectra for a series of ink drawdowns on paper substrates at different concentrations of Compound B as described in U.S. Pat. No. 7,914,703.

FIG. 2b depicts the normalized fluorescence spectra for the same series of ink drawdowns on paper substrates as in 2a, under excitation at 470 nm.

FIG. 2c shows the large Stokes shift of 157 nm for prints of an ink composition containing 2% of Compound B.

FIG. 3a depicts the fluorescence emission spectra of four printed fluorescent taggant inks containing Rhodamine B at different concentration levels.

FIG. 3b depicts the reflectance spectra of four printed fluorescent taggant inks containing Rhodamine B at different concentration levels.

FIG. 4 shows simulated images of a printed security mark in different wavelength ranges of illumination. Image 31 is a fluorescence image of a mark illuminated at 500 nm with fluorescent emission light detected through a bandpass filter at 700 nm. Image 32 is a reflected image of a security mark illuminated at about 950 nm. Image 33 is a reflected image of a security mark illuminated with light in the 400-700 nm range.

FIG. 5 is a flowchart that describes the authentication process of an optical detection method.

FIG. 6 illustrates a schematic of an optical imaging system. 51 is a cabinet shielded from room lights; 52 is a camera; 53 is a camera lens; 54 is a removable filter; 55 is a printed image on a surface; 56 is a 470 nm wavelength blue ring light; 57 is an 850 nm NIR ring light; 58 is a 400-700 nm white ring light.

### DETAILED DESCRIPTION OF THE INVENTION

The present invention relates to a method of producing a security mark by printing with a security ink, and an optical detection method to authenticate the security mark. The security mark exhibits reflectance and emission characteristics under illumination with light in specific wavelength ranges, which are dependent on the chemical structure and intermolecular interactions of the marker compounds in the ink. The authentication method verifies the specific optical characteristics of the printed security ink that result from the chemical composition of the ink containing the marker compounds and the printing conditions.

It is to be understood that the foregoing general description and the following detailed description are exemplary and explanatory only, and are not restrictive of any subject matter claimed.

Headings are used solely for organizational purposes, and are not intended to limit the invention in any way.

Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose. Although any methods and materials similar or equivalent to those described herein can be used in the practice or testing of the present invention, the preferred methods are described.

### Definitions

In this application, the use of the singular includes the plural unless specifically stated otherwise. As used herein, the singular forms “a,” “an” and “the” are intended to include the plural forms as well, unless the context clearly indicates otherwise.

In this application, the use of “or” means “and/or” unless stated otherwise. Also, when it is clear from the context in which it is used, “and” may be interpreted as “or,” such as in a list of alternatives where it is not possible for all to be true or present at once.

As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”

When the terms “consist of”, “consists of” or “consisting of” is used in the body of a claim, the claim term set off with “consist of”, “consists of” and/or “consisting of” is limited to the elements recited immediately following “consist of”, “consists of” and/or “consisting of”, and is closed to unrecited elements related to that particular claim term. The term ‘combinations thereof’, when included in the listing of the recited elements that follow “consist of”, “consists of” and/or “consisting of” means a combination of only two or more of the elements recited.

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

It is to be understood that wherein a numerical range is recited, it includes the end points, all values within that range, and all narrower ranges within that range, whether specifically recited or not.

Throughout this disclosure, all parts and percentages are by weight (wt % or mass % based on the total weight) and all temperatures are in ° C. unless otherwise indicated.

As used herein, “substrate” means any surface or object to which an ink or coating can be applied. Substrates include, but are not limited to, cellulose-based substrates, paper, paperboard, fabric (e.g. cotton), leather, textiles, felt, concrete, masonry, stone, plastic, plastic or polymer film, spunbond non-woven fabrics (e.g. consisting of polypropylene, polyester, and the like) glass, ceramic, metal, wood, composites, combinations thereof, and the like. Substrates may have one or more layers of metals or metal oxides, or other inorganic materials. Particularly preferred are non-woven substrates.

As used herein, the term “article” or “articles” means a substrate or product of manufacture. Examples of articles include, but are not limited to: substrates such as cellulose-based substrates, paper, paperboard, plastic, plastic or polymer film, glass, ceramic, metal, composites, and the like; and products of manufacture such as publications (e.g. brochures), labels, and packaging materials (e.g. cardboard sheet or corrugated board), containers (e.g. bottles, cans), a polyolefin (e.g. polyethylene or polypropylene), a polyester (e.g. polyethylene terephthalate), a metalized foil (e.g. laminated aluminum foil), metalized polyester, a metal container, and the like.

As used herein, “inks and coatings,” “inks,” and “coatings” are used interchangeably, and refer to compositions of the invention, or, when specified, compositions found in the prior art (comparative). Inks and coatings typically contain resins, solvent, and, optionally, colorants. Coatings are often thought of as being colorless or clear, while inks typically include a colorant.

As used herein, the terms “aggregation induced emission” or “AIE” refers to a photophysical phenomenon exhibited by a group of luminogenic materials that are non-emissive or weakly emissive when they are dissolved in good solvents as molecules (monomers), but become highly luminescent when they are clustered in poor solvents or in a solid state as aggregates.

The term “J-aggregate,” as used herein, refers to a supramolecular organization or assembly of many individual luminogenic or fluorescent molecules in close proximity to each other, organized in such a way that the peak fluorescence of the assembly shifts to a wavelength that is higher than the peak fluorescence wavelength of fully dissolved and monomeric molecules.

As used herein, a “fluorescence” is the light emitted by certain compounds that absorb light at a certain wavelength, and emit light at a higher wavelength.

As used herein, a “reflectance” is the amount of radiation reflected from a surface compared to the amount of incoming radiation.

As used herein, a “full width at half maximum (FWHM)” value of a fluorescence spectrum means the width of a spectrum curve measured between the points on the x-axis which are at half of the maximum peak emission intensity.

As used herein, “Stokes shift” refers to the difference in wavelength between the peak absorption and peak emission spectra.

As used herein, “image capture utilities” means an assembly of hardware, such as a computer that is in communication with the camera, and special software on the computer to analyze the image that is captured by the camera.

As used herein, a “bandpass filter” or “optical filter” is a filter that allows a certain spectrum of light to transmit through the camera lens, while blocking unwanted wavelengths using absorption, reflection, or both. For example, passing the light from a light source through a bandpass filter to illuminate a printed security mark will result in the printed security mark being illuminated only at the desired wavelengths, or range of wavelengths.

### Security Taggant System

The absorbance and fluorescence spectral characteristics for the security taggant system of the present application result from aggregation of special organic materials that have uncommon chemical characteristics. These uncommon chemical characteristics induce the observed changes in their absorbance and fluorescence spectra, and make them different from the monomeric form of the same materials. Use of these special organic materials exhibiting red-shifted fluorescence in an aggregated state in a printed ink allows for their verification by both their altered fluorescence and strong reflectance spectra. In addition, the altered shapes of the reflectance and fluorescence spectra provide unusual characteristics for verification, which are not easily achieved by using commonly available fluorescent materials.

Fluorescent chemicals are commonly used in security inks for printing security features on substrates or objects to allow the authentication of the marked item by detecting the fluorescence of the markings under an appropriate excitation light source. Such chemicals typically produce fluorescence as monomeric molecules in solution, or as additives in certain inks. As the concentration of such materials increases in an ink formulation, the corresponding fluorescence intensity may reach a saturation point and then it would decrease due to a quenching mechanism caused by intermolecular interactions (aggregation) between the fluorescent molecules. Many organic fluorescent chemicals with visible or near infrared emission have a visible color when dissolved in solvents or incorporated in clear inks. Such materials show reduction of their fluorescence light as the concentration of the material in a solvent or ink increases. An additional effect of the increased concentration is the darkening of the visible color of the material. This darkening or increase in the strength of color is not associated with a change in the perceived or measured color of the material (hue). The majority of organic fluorescent materials have little or no fluorescence in solid form. Certain techniques, such as encapsulation in polymer, or inclusion in vesicles, micelles, or host materials (such as cyclodextrins) may be used to enhance the fluorescence of such materials.

Unlike regular fluorescent dyes, there is a class of fluorescent compounds that have little or no fluorescence in solutions or in liquids at low concentrations, and their fluorescence intensity increases as the dye molecules aggregate by changing the solvent composition, adding other chemicals, or increasing the dye concentration substantially toward solid formation (e.g. crystallization). The observed enhanced fluorescence for such materials is called aggregation induced emission (AIE). Although materials that exhibit AIE are less readily available than regular fluorescent dyes, they do not necessarily provide sufficient advantages over commonly available fluorescent chemicals.

In all the cases indicated above, changes in the intensity of fluorescence for a given material as a function of concentration, or inclusion in special micro-environments, or aggregation induced emission as described above, do not substantially cause a shift in its fluorescence spectrum.

Given the widespread availability of different types of fluorescent materials, their use as security features may easily be compromised by direct substitution or by mimicking their fluorescence behavior by using alternative materials.

In order to increase the security level for a fluorescent marking system or taggant, it is important to use various methods to minimize or eliminate the likelihood for duplicating or mimicking the security effect. A number of techniques may be used to achieve these enhancements, including use of scarce materials with uncommon and multiple optical characteristics, and/or using materials that allow modification of their optical properties to meet desired detection and verification criteria.

Use of materials meeting the above criteria as taggants with increased level of security, is described in this disclosure. It is also important that such materials can be manufactured in sufficient quantities and used in commercial applications.

Typical fluorescent materials that are used for security marking are commonly available and can easily be duplicated or mimicked at relatively low cost. Materials with optical characteristics that cannot be easily duplicated or mimicked, provide a higher level of security and they are more valuable than more conventional security products. Higher security levels for marking and authentication are always in demand to protect against fraudulent documents or products, and they offer differentiation compared to competitors.

The surprisingly strong, red-shifted fluorescence in an aggregated state of some organic molecules unexpectedly arises when optimal conditions are created that lead organic molecules to form emissive J-aggregates. The term “J-aggregate,” as used herein, refers to a supramolecular organization or assembly of many individual luminogenic or fluorescent molecules in close proximity to each other, organized in such a way that the peak fluorescence of the assembly shifts to a wavelength that is higher than the peak fluorescence wavelength of fully dissolved and monomeric molecules.

For a detailed review on the subject of J-aggregates, refer to Würthner, F., Kaiser, T. E. & Saha-Möller, C. R. J-aggregates: From serendipitous discovery to supramolecular engineering of functional dye materials. Angew. Chemie-Int. Ed. 50, 3376-3410 (2011) and refer to Kaiser, T. E. J-Aggregates of Perylene Bisimide Dyes. Doctoral dissertation, Julius-Maximilians-Universität Würzburg (2009).

Although J-aggregate formation is not typical for dyes, a number of different organic dyes may be induced to form J-aggregates (e.g. by external factors such as adding materials such as cyclodextrins, metal organic framework, high salt concentration, anchoring to surfaces, encapsulation), which may include certain cyanines, merocyanines, squaraines, porphyrins, phthalocyanines, and perylene bisimides. J-aggregates are supramolecular structures containing many individual dye molecules. Close contact of the individual dye molecules leads to a large bathochromic shift (red shift) of the absorption and emission spectra versus the monomeric dyes. Strong fluorescence with small Stokes shift (the difference in wavelength between absorption and emission spectra) of considerably less than 50 nm may be observed in some J-aggregate structures. The formation of J-aggregates is highly dependent upon the preparation conditions used to disperse the dye material and is notably affected by temperature, solvent choice, and the introduction of surfactants or additives that induce aggregation.

An alternative competing aggregate structure is also possible, called the H-aggregate. H-aggregates have absorption bands shifted to shorter wavelength (hypsochromically shifted) versus the monomer absorption band, and fluorescence is weakened or quenched altogether.

In the present application, our security system is prepared with suitable dye molecules in a way that promotes the formation of strongly fluorescent aggregates that behave differently from previously observed H- and J-aggregates in certain ways. The materials disclosed in the current application form fluorescent aggregates that emit at wavelengths that are longer than that of the monomeric form of the dye, which is similar to J-aggregates. However, unlike typical J-aggregates, the absorption spectra for the aggregated form of the compounds used in the present invention do not appear at longer wavelengths than the monomeric form with small Stokes shift. The current materials show broadened spectra as the concentration increases, and appear substantially in the same spectral range as the monomeric form. This behavior results in a substantially larger Stokes shift between the absorption and emission spectra for the aggregated material, compared to regular fluorescent materials or their H- or J-aggregates. Typical Stokes shifts for organic fluorescent materials are in the range of several tens of nm, and typically below 50 nm. In contrast, the materials in the current disclosure exhibit Stokes shifts that are well in excess of 50 nm, and in some instances even well in excess of 100 nm.

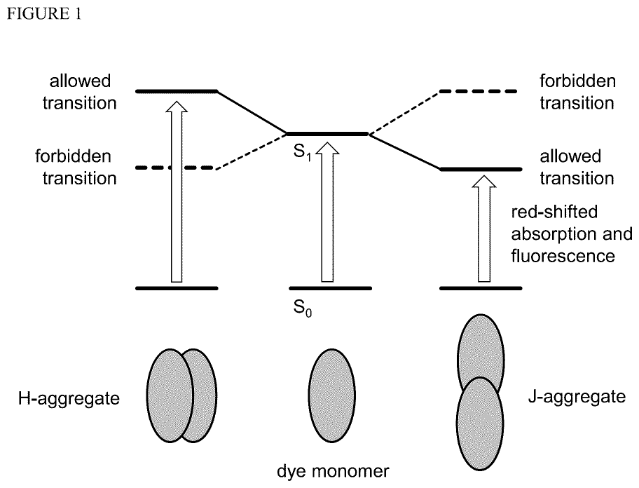

Examples of competing J- and H-aggregate structures and corresponding electronic energy level diagram shifts versus monomer dye are shown below in FIG. 1 for the ideal case of close-interacting dimers. H-aggregates are ideally stacked like playing cards face-on; whereas J-type aggregates are ideally stacked like playing cards edge-on, but there may actually be a continuum of offsetting angles possible between the two extremes.

J-aggregates are self-assembled supramolecular non-covalently bound structures; nevertheless, literature reports indicated that these structures are robust and persistent. J-aggregates formed in a solvent can subsequently be extruded into polymer films or spin-coated onto surfaces, remaining intact. Therefore, it is reasonable to expect J-aggregate structures formed in a solvent-based ink persist in the subsequently printed and dried ink also.

The red-shift of the fluorescence in J-aggregates has been interpreted as a delocalization of the electronic excited state over some number of coordinated dye molecules.

The following types of fluorescent dye molecules can form aggregates in solvent solutions: cyanines, merocyanines squaraines, porphyrins, phthalocyanines, and perylene bisimides. In particular, any of the dye molecules discussed in the Würthner review article on J-aggregates Angew. Chemie-Int. Ed. 50, 3376-3410 (2011) could fall in this category. The modified absorption and fluorescence spectra for J-aggregates, makes them less common compared to other fluorescent materials, which is a suitable characteristic for a security taggant. However, additional characteristics would be preferred for added security in a taggant for increased security.

The absorption spectrum for a J-aggregate is typically narrow compared to that of its monomeric parent compound. In addition, its fluorescence spectrum is also narrow, and it appears at a wavelength that is very close to its absorption band (e.g. less than 20 nm apart). Generating J-aggregates consistently in a printing ink for security marking may not be achieved by established methods for ink production and printing. A less common type of J-aggregate fluorescence with a broad and red-shifted spectrum may be generated by using molecules requiring complex synthesis and with integral host molecules such as cyclodextrins (U.S. Pat. No. 11,267,979).

In order to achieve a high level of security for a fluorescent material, it is desirable to produce highly aggregated materials that produce broad spectrum fluorescence under excitation by a suitable light source. It is also important for the aggregated material to possess strong visible color in its aggregated state so that it can be easily differentiated from common fluorescent materials that have strong emission in dilute, un-aggregated state. It is also desirable to be able to tune the fluorescence properties of the taggant by simple means, such as by adjusting concentration.

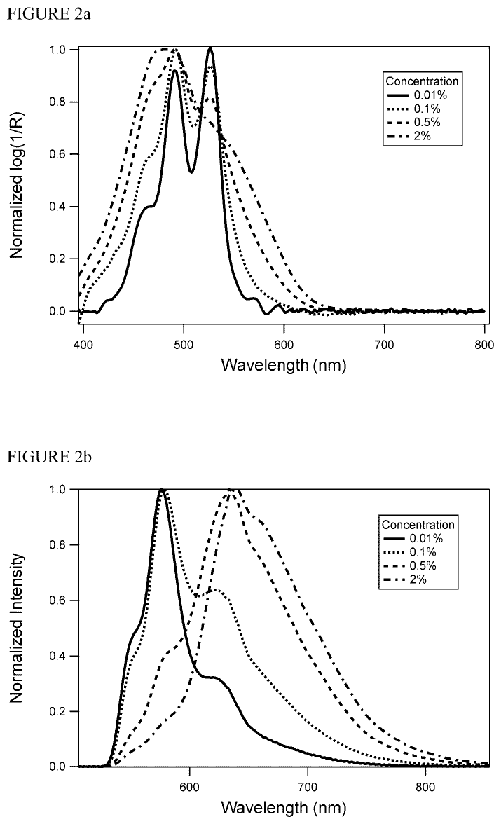

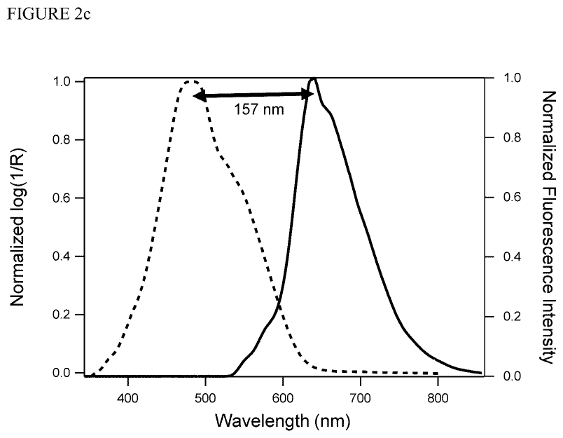

Careful examination of certain fluorescent dye molecules has revealed that their fluorescence is due to aggregation, which is accompanied by strong visible color as the concentration of the material in increased in an ink formulation. A number of the fluorescent poly(oxyalkylene)ated taggants described by Sun Chemical in U.S. Pat. Nos. 7,914,703, 8,211,333, and WO 2008/067445 follow this behavior. Some of the compounds described in these references undergo aggregation with a relatively large change in their absorbance (reflectance) spectra and shift in their fluorescence spectra to longer wavelengths. The red-shifted fluorescence spectra for these materials appear broad in comparison to the reported spectral shapes for typical J-aggregate spectra. The formation of such broad and red-shifted fluorescence spectra is relatively uncommon, even compared to materials that form J-aggregates under special conditions such as in the presence of secondary stimuli such as cyclodextrins as disclosed in U.S. Pat. No. 11,267,979. Compound B, as described in Example 1 of U.S. Pat. No. 7,914,703, is a representative molecule that undergoes aggregation as a function of concentration increase, as indicated in its reflectance and fluorescence spectra, FIGS. 2a and 2b, respectively.

The concentration dependence of the fluorescence spectrum for Compound B and similar materials provides an additional characteristic by allowing wavelength tuning of the fluorescence that is useful for authentication of security marks containing this material. Because of the unusual combination of optical characteristics that can be generated for Compound B and similar materials by causing aggregation due to increased concentration, and without external stimuli or additives, a robust authentication technique may be used to verify the authenticity of a security mark containing such materials with a very high level of confidence. Such an authentication technique would verify the broad fluorescence spectrum at the concentration dependent wavelength range by examining its wavelength and intensity profiles. It would also examine the reflectance profile of the marking in the visible and near infrared spectral region as well as the apparent color of the marking. The combination of the features indicated above would constitute a signature that can be used for authentication of the security mark containing Compound B or similar materials.

In certain embodiments, the peak fluorescence of the aggregated taggant appears at a wavelength that is longer than the peak fluorescence wavelength of the monomeric/non-aggregated taggant by at least 40 nm when excited at the same first wavelength. In certain embodiments, the aggregated taggant will have a peak fluorescence that is longer than the peak fluorescence wavelength of the monomeric/non-aggregated taggant by at least 50 nm, or by at least 60 nm, or by at least 70 nm.

In some embodiments, the aggregated taggant has a fluorescence spectrum that has a full width at half maximum (FWHM) larger than 40 nm. For example, the aggregated taggant may have a fluorescence spectrum that has a FWHM larger than 50 nm, or larger than 60 nm, or larger than 70 nm.

In particular embodiments, the aggregated taggant emits a visible or near-infrared (near-IR) light resulting from absorption in the 400 to 700 nm spectral range. In certain embodiments, the aggregated taggant will appear as a color in visible light.

In some embodiments, the aggregated taggant has a minimum absorption in the near-IR, resulting in high reflectance at wavelengths higher than 700 nm.

An ink composition containing one or more types of these contemplated dye molecules is prepared in a way to form fluorescent aggregates dispersed in ink. By controlling the concentration of the above-described fluorescent molecules in an ink formulation, a target aggregation state may be achieved with a specific red-shifted fluorescence spectrum. The resulting aggregates persist in the finished ink and in the printed image formed from the dried ink.

FIG. 2a depicts the normalized reflectance spectra for a series of ink drawdowns on paper substrates at different concentrations of Compound B as described in U.S. Pat. No. 7,914,703.

FIG. 2b depicts the normalized fluorescence spectra for the same series of samples as in 2a, under excitation at 470 nm.

FIG. 2c depicts the measured Stokes shift between the peak of absorbance and fluorescence spectra for Compound B.

The taggants may be used in an ink formulation by conventional ink preparation methods. Inks are printed onto a surface to make a printed image. The surface may be composed of paper, metal, polymer film, glass, wood, or any known type of surface capable of being printed upon with the only limitation being that the printed surface has little or no background fluorescence in the range of wavelengths where the fluorescent taggant security mark fluoresces.

The method of surface printing may be gravure, flexographic, screen, inkjet, offset lithographic, letterpress, pad printing, or any method capable to transfer the ink fluid onto the surface to form a printed image.

The printed image may be dried or cured on the printed surface by solvent evaporation, by solvent penetration into the substrate, by heat-setting in a drying oven, by oxidative drying, by chemically induced curing, by ultraviolet light curing, by electron beam curing, by thermally induced curing or by any means to fix the solidified print image on the print surface.

The printed image will emit light in a wavelength range that is longer than that of the excitation light, which may cover the ultraviolet (UV) to red wavelength range. Due to the strong visible color of the aggregated material in the printed form, its reflectance in the visible range will correspond to the observed color, and it will lack similar reflectance in the near infrared (NIR) range of the spectrum. The unusual combination of several optical properties arising from a single molecule under special conditions gives a high level of security to the printed marks with this ink. These optical characteristics include fluorescence from an aggregated state, broad fluorescence spectrum, strong visible color, and lack of NIR absorbance. By concomitant detection of these optical properties, authentication of the printed marks with this security ink may be carried out with a high level of confidence.

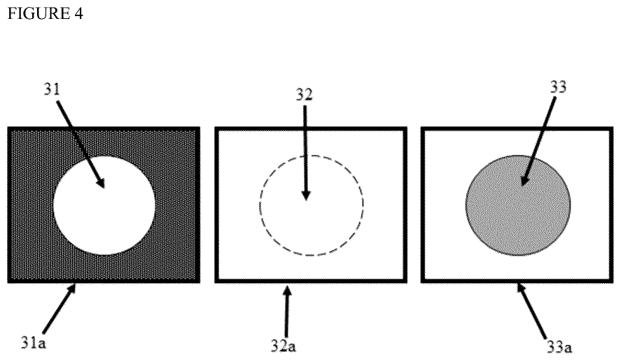

FIG. 4 shows the simulated appearance of a printed security mark on a surface when illuminated by light of different wavelengths. Image 31 is a fluorescence image of a printed security mark illuminated at 500 nm, with the fluorescent emission light detected through a bandpass filter at 700 nm. The fluorescent image 31 appears light on a dark background 31a. Image 32 is a reflected image of a security mark illuminated with light of approximately 950 nm. The security mark 32 is indistinguishable from the background 32a under this illumination condition. Image 33 is a reflected image of a security mark illuminated with light in the 400-700 nm range (visible light), resulting in a visible colored print.

The fluorescent taggant security mark will be imaged and recognized as an authentic security mark by an optical taggant detection method. This detection method may comprise an imaging system with a set of light sources, cameras, lens, filters, and image capture utilities to illuminate the security mark in varying wavelength ranges of light, to detect the absorption, reflection, and fluorescence of portions of the mark in varying wavelength ranges of light, and to acquire an image or multispectral images of the security mark to authenticate the security mark, distinguishing it from any other mark.

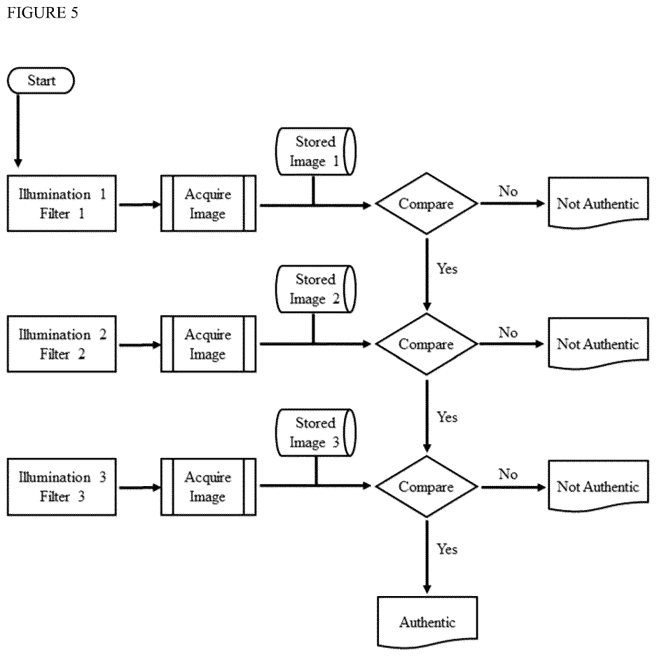

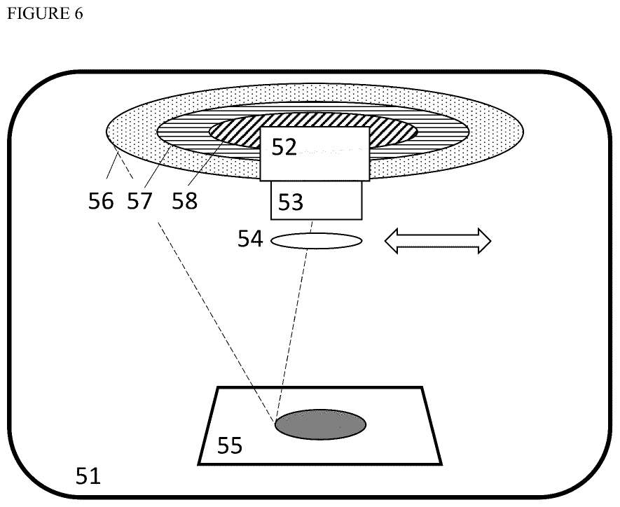

FIG. 5 shows a flowchart that describes the authentication process of an optical detection method. The process starts by placing the substrate with the printed security mark to be tested in the optical imaging apparatus. In the Illumination 1 step, the security mark is illuminated by a first light source, through a filter 1 that allows only a certain wavelength or range of wavelengths to pass through and illuminate the printed security mark i.e. wavelength 1, the spectral image is captured, and compared to a stored standard image 1. If the spectra do not match, the printed security mark is not authentic, and the process is terminated. If the spectra match, the security mark passes the first level of authentication, and it moves to the next step of the process. In the Illumination 2 step, the security mark is illuminated by a second light source, through a filter 2 that allows only a certain wavelength or range of wavelengths to pass through and illuminate the printed security mark i.e. wavelength 2, the spectral image is captured, and compared to a stored standard image 2. If the spectra do not match, the printed security mark is not authentic, and the process is terminated. If the spectra match, the security mark passes the second step of authentication, and it moves to the next step. In the Illumination 3 step, the security mark is illuminated by a third light source, through a filter 3 that allows only a certain wavelength or range of wavelengths to pass through and illuminate the printed security mark i.e. wavelength 3, the spectral image is captured, and compared to a stored standard image 3. If the spectra do not match, the security mark is not authentic, and the process is terminated. If the spectra match, the printed security mark has passed all three Illumination steps, and is deemed to be authentic.

FIG. 6 shows a schematic of an optical imaging system. 51 is a cabinet shielded from room lights; 52 is a camera; 53 is a camera lens; 54 is a removable filter; 55 is a printed image on a surface; 56 is a 470 nm wavelength blue ring light; 57 is an 850 nm NIR ring light; 58 is a 400-700 nm white ring light. In some embodiments, the optical imaging system will comprise an electronic sensor with one of more detection channels with optical filters. The optical imaging system may also comprise an electronic control circuit, and a control program for data capture.

### EXAMPLES

The present invention is further described by the following non-limiting examples, which further illustrate the invention, and are not intended to, nor should they be interpreted to, limit the scope of the invention.

### Example 1. Method of Preparing Ink Composition 1 for the Inventive Security Mark

This method was used for the preparation of an ink containing 0.5% by weight of Compound B from U.S. Pat. No. 7,914,703. Compound B is a preferred example of a molecule that forms aggregate self-assembled supramolecular structures with broad-spectrum red-shifted fluorescence that is highly dependent upon preparation conditions. The components listed in Table 1 were mixed with solvents to form a homogeneous varnish. Subsequently, 1 part of Compound B was added to 199 parts of the varnish and mixed to make the finished ink combination shown in Table 1 containing 0.5% fluorescent taggant.

TABLE 1
Formula for Composition 1 containing Compound B

| Material | Type | wt. % |
|---|---|---|
| SUN 940-1151 | Polyurethane resin 1 | 22.88 |
| SUN 3-V-19 | Nitrocellulose | 15.92 |
| | varnish | |
| SUN 940-1133 | Polyurethane resin 2 | 16.92 |
| normal propyl alcohol | Solvent | 33.83 |
| normal propyl acetate | Solvent | 9.95 |
| Compound B | Fluorescent | 0.50 |
| | molecule | |
| Total | | 100 |

Ink Composition 1 was proofed with a k-bar onto white polyolefin film and dried to make a print with highly absorbing maroon color when illuminated with visible light between 400-700 nm. The print had a peak fluorescent emission significantly red-shifted and broadened at 634 nm. (See FIGS. 2b and 2c) The print did not show detectable absorption in the near infrared above 700 nm as demonstrated in FIG. 2a. The large Stokes shift of 157 nm is demonstrated in FIG. 2c for prints of an ink composition having the same basic formulation as Ink Composition 1, but containing 2% of Compound B.

### Example 2. Method of Preparing a Comparative Ink Composition 2

This method was used for preparations of an ink containing Rhodamine B. Rhodamine B is an example of a typical molecule that does not exhibit aggregation. The molecule was blended into a water-based ink with concentrations ranging between 0.01 wt. % and 2 wt. %.

TABLE 2
Formula for comparative Ink Composition
2 containing Rhodamine B

| Material | Type | Amount (wt %) |
|---|---|---|
| Joncryl HR 1620 | Resin emulsion | balance |
| Rhodoline 999 | Defoamer | 0.4 |
| Low angle wax | Additive | 1.0 |
| Water | Solvent | 10.0 |
| Vancryl 68SN | Resin solution | 15.0 |
| Surfynol 440 | Surfactant | 0.6 |
| Rhodamine B | Fluorescent molecule | |

| | |
|---|---|
| Total | 100.0 |

Ink Composition 2 was proofed with a k-bar onto Leneta Form 3B boards and dried to make prints with highly absorbing pink color when viewed in visible light between 400-700 nm.

Fluorescence spectra and absorption spectra of prints were measured using a Thorlabs Fiber Spectrometer. The excitation light for fluorescence was provided by a 385 nm LED, and a 515 nm cut-off filter was used. The absorption spectra were obtained using a Thorlabs SLS201 light source for broadband illumination. Reflectance was measured versus an unprinted Leneta 3B white background, and the spectra are presented in absorption units as an inverse log transform. All spectra were normalized for comparison.

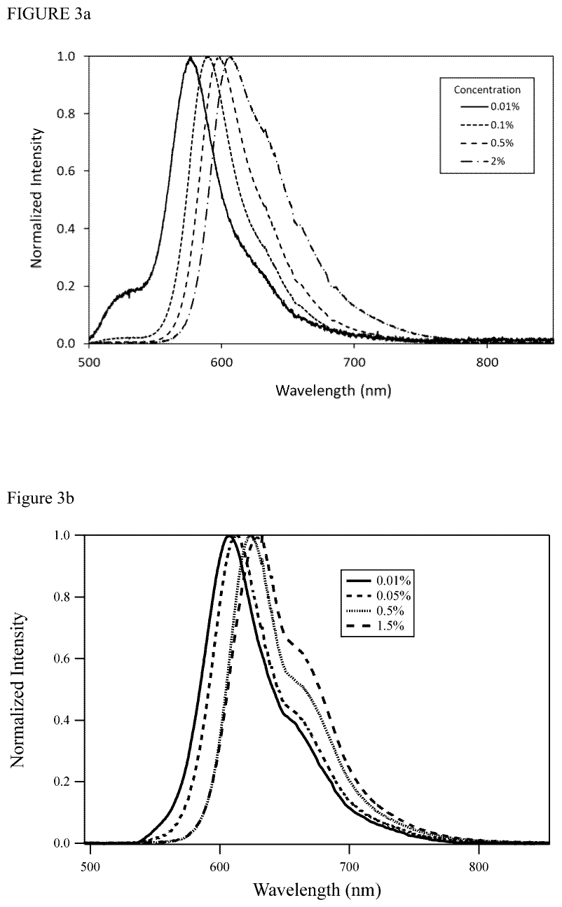

The prints had a peak fluorescent emission at 577 nm, which red-shifted to 607 nm at high concentration. The emission spectrum did not significantly broaden with increasing concentration. (See FIG. 3a)

### Example 3. Method of Preparing Comparative Ink Composition 3 Containing Oracet Fluorescent Red 305

This method was used for preparations of an ink containing Oracet Fluorescent Red 305, which is another example of a fluorescent dye that does not exhibit aggregation. The molecule was blended into a solvent-based ink with concentrations ranging between 0.01 wt. % and 1.5 wt. % based on the formula presented in Table 3.

TABLE 3
Formula for comparative Ink Composition
3 containing Oracet Fluorescent Red 305

| Material | Type | Amount (wt. %) |
|---|---|---|
| Acetone | Solvent | 11.9 |
| NC Varnish A | Resin | 23 |
| NC Varnish B | Resin | 54.6 to 56.1 |
| Vikoflex | Plasticizer | 9 |
| Oracet ® FL | Fluorescent | 0.01 to 1.5 |
| Red 305 | Molecule | |

| | |
|---|---|
| Total | 100 |

Ink Composition 3 was proofed with a k-bar onto Leneta Form 3B boards and dried to make prints with highly absorbing maroon color when viewed in visible light between 400-700 nm.

Fluorescence spectra and absorption spectra of prints were measured using a Thorlabs Fiber Spectrometer. The excitation light for fluorescence was provided by a 385 nm LED, and a 515 nm cut-off filter was used. The absorption spectra were obtained using a Thorlabs SLS201 light source for broadband illumination. Reflectance was measured versus an unprinted Leneta 3B white background, and the spectra are presented in absorption units as an inverse log transform. All spectra were normalized for comparison.

The prints had a peak fluorescent emission at 606 nm, which red-shifted to 627 nm at high concentration. The emission spectrum did not show broadening with increasing concentration. (See FIG. 3b).

The present invention has been described in detail, including the preferred embodiments thereof. However, it will be appreciated that those skilled in the art, upon consideration of the present disclosure, may make modifications and/or improvements on this invention that fall within the scope and spirit of the invention.

1. A method of producing a substrate with a printed security mark, comprising:
(a) providing a substrate;
(b) providing a security ink, wherein the security ink comprises a taggant, wherein the taggant is an organic compound that forms a fluorescent aggregate with a Stokes shift of greater than 50 nm as its concentration increases, without the use of any aggregation-inducing additives;
(c) printing the security ink on the substrate; and
(d) drying or curing the security ink on the substrate;
to provide a substrate with a printed security mark.

2. The method of claim 1, wherein the aggregated taggant has altered fluorescence and reflectance spectra compared to the monomeric/non-aggregated form of the same organic compound.

3. The method of claim 1, wherein the aggregated taggant produces fluorescence at a second wavelength when excited by light of a first wavelength.

4. The method of claim 1, wherein the peak fluorescence of the aggregated taggant appears at a wavelength that is longer than the peak fluorescence wavelength of the monomeric/non-aggregated taggant by at least 40 nm when excited at the same first wavelength.

5. The method of claim 1, wherein the aggregated taggant has a fluorescence spectrum that has a full width at half maximum (FWHM) larger than 40 nm.

6. The method of claim 1, wherein the aggregated taggant emits a visible or near-infrared light resulting from absorption in the 400 to 700 nm spectral range.

7. The method of claim 1, wherein the aggregated taggant has a minimum absorption in the near-infrared (NIR) resulting in high reflectance at wavelengths higher than 700 nm.

8. A method of authenticating a security mark printed on a substrate, comprising:
(a) providing an authentication assembly, wherein the assembly comprises:
i. one or more light sources;
ii. one or more cameras;
iii. one or more lenses;
iv. one or more light filters; and
v. image capture utilities;
(b) providing a substrate with a printed security mark prepared by the method of claim 1;
(c) placing the substrate with the printed security mark in front of the camera in the assembly;
(d) illuminating the substrate with the printed security mark with a specific wavelength of light suitable for the security mark;
(e) detecting and measuring absorption, reflection, or fluorescence of all or portions of the security mark on the substrate with a printed security mark when illuminated with light, using the image capture utilities;
(f) acquiring one image of the security mark at a first wavelength, or one or more multispectral images of the security mark at varying wavelengths, using the image capture utilities; and
(g) comparing the spectral images of the security mark to a known standard;
wherein a match to the known standard indicates authenticity of the security mark, and distinguishes it from counterfeit marks.

9. A method of authenticating a security mark printed on a substrate, comprising:
(a) providing an authentication device, wherein the authentication device comprises:
i. one or more light sources;
ii. an electronic sensor with one or more detection channels with optical filters;
iii. an electronic control circuit; and
iv. a control program for data capture;
(b) providing a substrate with a printed security mark prepared by the method of claim 1;
(c) placing the substrate with the printed security mark in front of the authentication device;
(d) illuminating the substrate with the printed security mark with a specific wavelength of light suitable for the security mark;
(e) detecting and measuring the fluorescence of all or portions of the security mark on the substrate with the printed security mark when illuminated with light, using the device control program;
(f) comparing the sensor data of the security mark to a known standard;
wherein a match to the known standard indicates the authenticity of the security mark, and distinguishes it from counterfeit marks.
